(19) United States
(12) Patent Application Publication
(10) Pub. No.: US 2007/0262249 A1
(43) Pub. Date: Nov. 15, 2007

(54) Encoder having angled die placement

(76) Inventors: Chuen Cheak Lee, Darul Ehsan (MY); Cheng Why Tan, Panang (MY)

Correspondence Address: Kathy Manke;Avago Technologies Limited, 4380 Ziegler Road, Fort Collins, CO, 80525, US

(21) Appl. No.: 11/432,646

(22) Filed: May 11, 2006

(51) Int. Cl. G01D 5/34

(52) U.S. Cl. 250/231.13

(57) ABSTRACT

An optical encoder including a leadframe substrate, an emitter, and a detector is disclosed. The leadframe substrate bent to include a base portion, an emitter portion and a detector portion. The emitter, for emitting light, is mounted on the emitter portion. The detector, for detecting light, is mounted on the detector portion. The emitter portion lies at an emitter angle relative to the base portion such that light emitted by the emitter is generally directed at a desired direction. The detector portion lies at a detector angle relative to the base portion such that reflected light is captured by the detector. Due to the angles at which the emitter and the detector are mounted, lenses are not necessary; however, even if lenses are used, the encoder is more robust towards manufacturing tolerances of the lenses.

### BACKGROUND

The present invention relates generally to optical encoders. More particularly, the present invention relates to optical encoders having various die orientations.

Optical encoders detect motion and typically provide closed-loop feedback to a motor control system. When operated in conjunction with a code scale, an optical encoder detects motion (linear or rotary motion of the code scale), converting the detected motion into digital signal that encode the movement, position, or velocity of the code scale. Here, the phrase “code scale” includes code wheels and code strips.

Usually, motion of the code scale is detected optically by means of an optical emitter and an optical detector. The optical emitter emits light impinging on and reflecting from the code scale. A typical code scale includes a regular pattern of slots and bars that reflect light in a known pattern. Light is either reflected or not reflected from the code scale. The reflected light is detected by the optical detector. As the code scale moves, an alternating pattern of light and dark corresponding to the pattern of the bars and spaces reaches the optical detector. The optical detector detects these patterns and produces electrical signals corresponding to the detected light, the electrical signals having corresponding patterns. The electrical signal, including the patterns, can be used to provide information about position, velocity and acceleration of the code scale.

FIG. 1A illustrates a cross sectional side view schematic of a known optical encoder 100 and a code scale 120. FIG. 1B is the code scale 120 as viewed from the optical encoder 100. FIGS. 1A and 1B include orientation axes legend for even more clarity.

Referring to FIGS. 1A and 1B, the encoder 100 includes an optical emitter 102 and an optical detector 104 mounted on a substrate 106 such as a lead frame 106. The optical emitter 102 and the optical detector 104 as well portions of the lead frame 106 are encapsulated in an encapsulant 108 including, for example, clear epoxy. The encapsulant 108 defines a first dome-shaped surface 110 (first lens 110) over the optical emitter 102 and a second dome-shaped surface 112 (second lens 112) over the optical detector 104.

The optical emitter 102 emits light 114 that leaves the encapsulant 108 via the first lens 110. The first lens 110 concentrates or directs the emitted light 114 toward the code scale 120, the light reflecting off of the code scale 120. The reflected light 116 reaches the optical detector 104 via the second lens 112. The second lens 112 concentrates or directs the reflected light toward the optical detector 104. The optical detector 104 can be, for example only, photo detector that converts light into electrical signals.

The shape and the size of the first lens 110 and the second lens 112 are dictated by various factors such as, for example only: the distance of the code scale 102 from the lenses 110 and 112 and the characteristics of the emitter 102 and the detector 104. Often, space 118 between the lenses 110 and 112 is filled with the same encapsulant 108 material and has a flat surface 117.

There exists an ever increasing demand for increasing performance, which, in turn, requires smaller packaging, higher resolution, and tighter tolerances. Using the prior art configuration, it is difficult to achieve higher performances because, for example, the performance of the encoders are sensitive to the size and the shape of the lenses; however, it is difficult to consistently produce the desired size and the desired shape of the lenses 110 and 112 using current molding techniques. Furthermore, the lenses require a separation distance 130 between the location of emitter and the detector and the code scale 120. This is to accommodate the bulk of the lenses 110 and 112 as well as for focal distance between the emitter-detector pair and the code scale 120, the focal distance determined by the lenses 110 and 112.

Accordingly, there remains a need for improved optical encoder that alleviates or overcomes these shortcomings.

### SUMMARY

The need is met by the present invention. In a first embodiment of the present invention, optical encoder includes a leadframe substrate, an emitter, and a detector. The leadframe substrate includes a base portion, an emitter portion and a detector portion. The emitter is operable to emit light. The emitter is mounted on the emitter portion of the leadframe substrate. The detector is operable to detect light. The detector is mounted on the detector portion of the leadframe substrate. The emitter portion of the leadframe substrate lies at an emitter angle relative to the base portion such that light emitted by the emitter is generally directed at a desired direction.

The detector portion of the leadframe substrate lies at a detector angle relative to the base portion such that light reflected from a code scale is generally directed toward the detector. In fact, the emitter angle and the detector angle have same absolute value.

The emitter and the detector are encapsulated by encapsulant. The encapsulant can be formed to define an emitter lens adapted to direct light from the emitter toward a desired direction. Further, the encapsulant can be formed to define a detector lens adapted to direct reflected light toward the detector.

In a second embodiment of the present invention, an optical encoder includes a substrate defining a cavity having surfaces. An emitter, operable to emit light, is mounted on a first surface of the cavity. A detector, operable to detect light, is mounted on a second surface of the cavity.

The substrate can be, for example, can be a leadframe substrate or a silicon substrate, depending on desired implementation. The emitter is positioned such that emitted light is generally directed up and toward the center of the cavity. The detector is positioned generally facing up and center of the cavity.

In a third embodiment of the present invention, a method of manufacturing an apparatus is disclosed. First, a leadframe substrate is provided. An emitter is mounted on the leadframe substrate. A detector is mounted on the leadframe substrate. The leadframe is bent such that a base portion and an emitter portion are formed, the emitter portion resulting at an emitter angle relative to the base portion.

When the substrate is bent, a detector portion is also formed, the detector portion resulting at a detector angle relative to the base portion. The emitter angle and the detector angle can have the same absolute value. The emitter and the detector is encapsulated using clear encapsulant.

In a fourth embodiment of the present invention, a method of manufacturing an apparatus is disclosed. A substrate is provided. A cavity is fabricated in the substrate, the cavity defining surfaces. An emitter is mounted on a first surface of the cavity. A detector is mounted on a second surface of the cavity.

The emitter is positioned such that emitted light is generally directed up and toward the center of the cavity. The detector is positioned generally facing up and center of the cavity.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1A illustrates a cut away side view of a prior art optical encoder and a sample code scale;

FIG. 1B illustrates the sample code scale of FIG. 1A as viewed from the optical encoder of FIG. 1A;

FIG. 2 illustrates an optical encoder in accordance with a first embodiment of the present invention;

FIG. 3 illustrates an optical encoder in accordance with a second embodiment of the present invention;

FIG. 4 illustrates an optical encoder in accordance with a third embodiment of the present invention;

FIG. 5 illustrates an optical encoder in accordance with a fourth embodiment of the present invention;

FIG. 6 is a flowchart illustrating another aspect of the present invention;

FIGS. 7A and 7B illustrate portions of the first embodiment of the present invention during various stages of manufacture; and

FIG. 8 is a flowchart illustrating yet another aspect of the present invention.

### DETAILED DESCRIPTION

The present invention will now be described with reference to the Figures which illustrate various embodiments of the present invention. In the Figures, some sizes of structures or portions may be exaggerated and not to scale relative to sizes of other structures or portions for illustrative purposes and, thus, are provided to illustrate the general structures of the present invention. Furthermore, various aspects of the present invention are described with reference to a structure or a portion positioned “on” or “above” relative to other structures, portions, or both. Relative terms and phrases such as, for example, “on” or “above” are used herein to describe one structure's or portion's relationship to another structure or portion as illustrated in the Figures. It will be understood that such relative terms are intended to encompass different orientations of the device in addition to the orientation depicted in the Figures.

For example, if the device in the Figures is turned over, rotated, or both, the structure or the portion described as “on” or “above” other structures or portions would now be oriented “below,” “under,” “left of,” “right of,” “in front of,” or “behind” the other structures or portions. References to a structure or a portion being formed “on” or “above” another structure or portion contemplate that additional structures or portions may intervene. References to a structure or a portion being formed on or above another structure or portion without an intervening structure or portion are described herein as being formed “directly on” or “directly above” the other structure or the other portion. Same reference number refers to the same elements throughout this document.

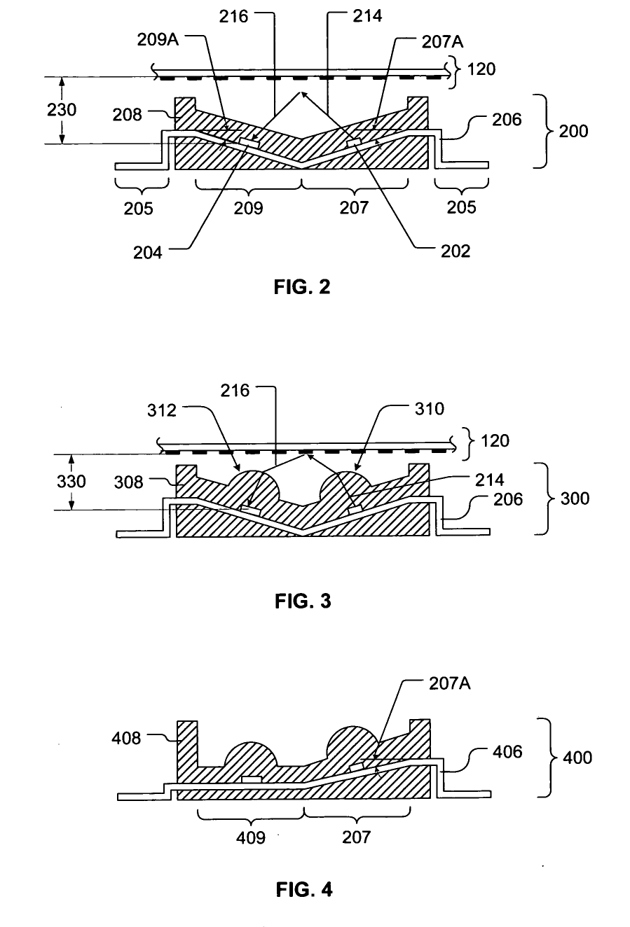

FIG. 2 illustrates an optical encoder 200 in accordance with one embodiment of the present invention. Referring to FIG. 2, the optical encoder 200 includes a leadframe substrate 206 having a base portion 205, an emitter portion 207, and a detector portion 209. An optical emitter 202 is operable to emit light. The emitter 202 is mounted on the emitter portion 207 of the substrate 206. An optical detector 204 is mounted on the detector portion 209 of the leadframe substrate 206. The detector 204 is operable to detect light to generate electrical signal in response to the detected light.

The emitter portion 207 of the leadframe substrate 206 lies at an emitter angle 207A relative to the base portion 205 such that light 214 emitted by the emitter 202 is generally directed at a desired direction. In the illustrated example, the desired direction is toward a code scale 120 and generally in the direction toward the detector 204. Light rays 214 and similar indicators in the Figures are used to illustrate general direction of the light; these ray indicators are not intended to be trace rays oft used in the field of optics.

The detector portion 209 of the leadframe substrate 206 lies at a detector angle 209A relative to the base portion 205 such that reflected light 216 (light reflected from a code scale 120) is generally directed toward the detector 204. In the illustrated example, the emitter angle 207A and the detector angle 209A have opposing direction; however, the absolute value of the emitter angle 207A and the absolute value of the detector angle 209A. The emitter 202 and the detector 204 are encapsulated by encapsulant 208 material.

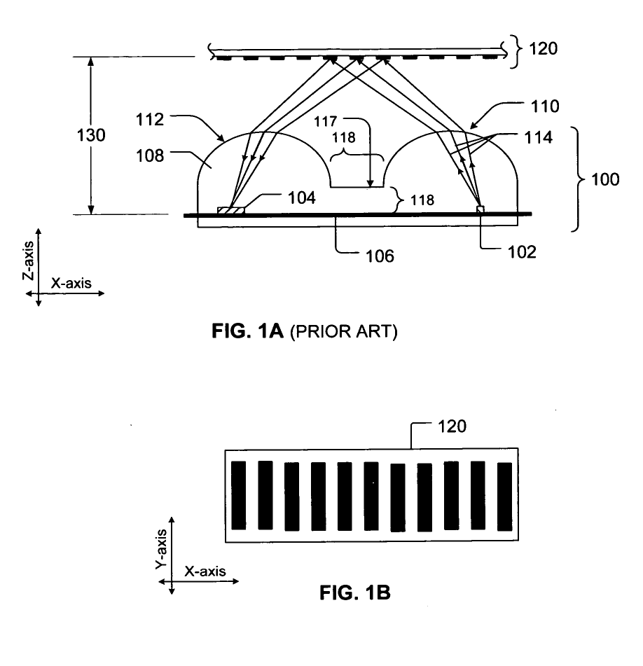

As illustrated, due to the angled mounting of the emitter 202 and the detector 204, the emitted light 214 and the reflected light 216 are directed in the desired direction without requiring lenses as required in the optical encoder 100 of FIG. 1. For at least this reason, separation distance 230 between the emitter 202 and the code scale 120 can be much less than the separation distance 130 of FIG. 1. Accordingly, the device including the optical encoder 200 and the code scale 120 can be packaged in a smaller package.

Furthermore, since the code scale 120 is closer to the emitter 202 and the detector 204, either less light is needed to realize the same contrast and resolution compared to the prior art encoder 100 of FIG. 1, or the same amount of light provides higher contrast and resolution compared to the prior art encoder 100 of FIG. 1.

Further increases in performances can be realized by adding lenses even to the present invention. FIG. 3 illustrates an optical encoder 300 in accordance with another embodiment of the present invention. Portions of the optical encoder 300 are similar to corresponding portions of the optical encoder 200 illustrated in FIG. 2 and discussed above. To avoid repetition and clutter, the reference numerals for some similar portions are not repeated in the drawing and not discussed herein.

Referring to FIG. 3, the encoder 300 includes encapsulant 308 that defines an emitter lens 310 adapted to direct light from the emitter 202 toward the desired direction. Further, the encapsulant 308 defines a detector lens 312 adapted to direct reflected light 216 from the code scale 120 toward the detector 204. Using the lenses 310 and 312, separation distance 330 between the emitter-detector plane and the code scale 120 can be further decreased leading to even tighter packaging.

The emitter side and the detector side of the optical encoder need not be symmetrical. For example, FIG. 4 illustrates an optical encoder 400 in accordance with yet another embodiment of the present invention. Portions of the optical encoder 400 are similar to corresponding portions of the optical encoder 200 illustrated in FIG. 2 and to corresponding portions of the optical encoder 300 illustrated in FIG. 3. To avoid repetition and clutter, the reference numerals for some similar portions are not repeated in the drawing and not discussed herein.

Referring to FIG. 4, the encoder 400 includes encapsulant 408 includes a leadframe substrate 406 having an emitter portion 207 that lies at an emitter angle 207A relative to the base portion 205 such that light 214 emitted by the emitter 202 is generally directed at a desired direction. This is similar to the optical encoder 200 of FIG. 2. However, in the encoder 400, the detector portion 409 of lies horizontally as with the leadframe 206. Depending on the desired application, this configuration may be useful.

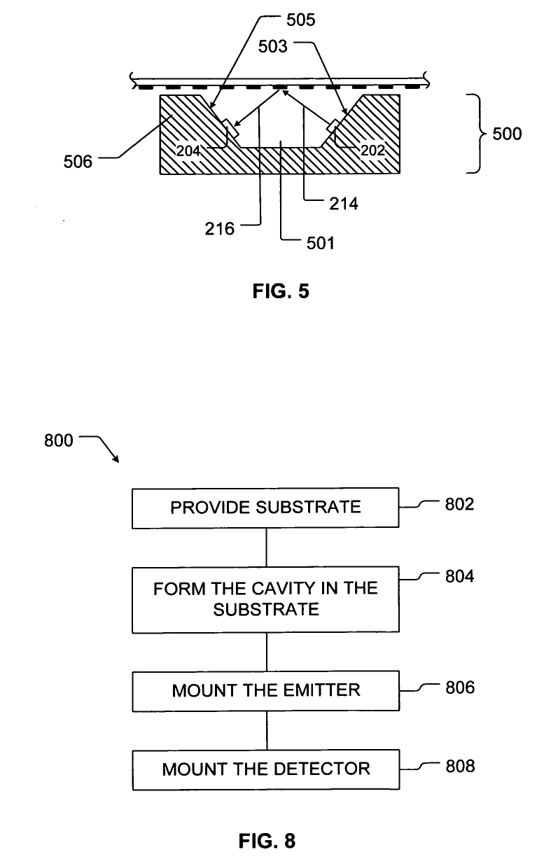

The present invention is adaptable to many other applications and implementations. For example, FIG. 5 illustrates an optical encoder 500 including yet another embodiment of the present invention. Referring to FIG. 5, a substrate 506, for example a silicon substrate is fabricated to include a cavity 507 having surfaces 503 and 505. An emitter 202 is mounted on the first surface 503 of the cavity 501, the emitter being operable to emit light. The emitter 202 is positioned such that emitted light is generally directed up and toward the center of the cavity 501. A detector 204 is mounted on the second surface 503 of the cavity 501, the detector being operable to detect light. The detector 204 is positioned generally facing center of the cavity so as to detect reflected light 216.

Here, the substrate 506 is a solid silicon substrate. This is an alternative implementation of the present invention compared to the implementations illustrated in FIGS. 2 through 4 where leadframe substrates 206 and 406 are used.

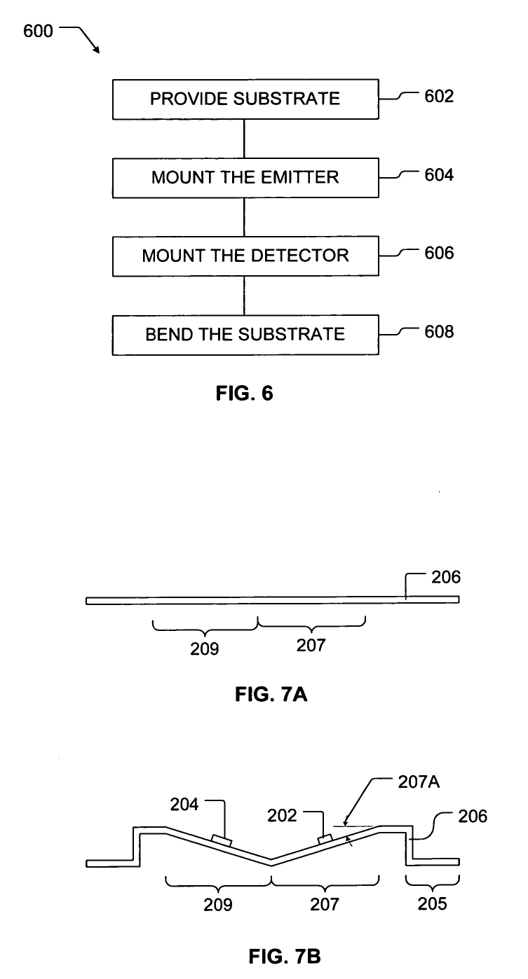

Another aspect of the present invention is a method of manufacturing an apparatus including an optical encoder such the encoder 200 of FIG. 2. FIG. 6 illustrates a flow chart 600 including the steps of the method in accordance with yet another aspect of the present invention. Referring to FIG. 6, a leadframe substrate is provided. Step 602. The leadframe substrate 206 is, at this stage of manufacture, a flat piece of leadframe having one or more connection traces. A cutaway side view of the provided leadframe 206 is illustrated in FIG. 7A.

Referring to FIGS. 6 through 7B, an emitter 202 is mounted on the leadframe substrate 206. Step 604. Also, a detector 204 is mounted on the leadframe substrate 206. Step 606. Then, the leadframe 206 is bent to form base portions 205 and an emitter portion 207. Step 608. The resulting shape of the bent leadframe is illustrated in FIGS. 7B and 2 as the leadframe 206. Portions of FIG. 2 including the leadframe 206 are reproduced as FIG. 7B for convenience of discussion. The bent leadframe 206 includes the base portions 205, the emitter portion 207, and the detector portion 209. The emitter portion is at the emitter angle 207 relative to the base portion 205. Finally, the emitter 202, the detector 204, and portions of the substrate 206 are encapsulated using encapsulant 208 such as clear epoxy, resulting in the optical encoder 200 of FIG. 2.

In alternative embodiments, the steps of the flowchart 600, with slight modifications, can be use to manufacture the optical encoder 300 of FIG. 3 and the optical encoder 400 of FIG. 4. For example, to manufacture the optical encoder 300 of FIG. 3, during the encapsulation step, the encapsulant is used to form the lenses 310 and 312 of FIG. 3.

Yet another aspect of the present invention is a method of manufacturing an apparatus including an optical encoder such the optical encoder 500 of FIG. 5. FIG. 8 illustrates a flow chart 800 including the steps of the method in accordance with yet another aspect of the present invention. Referring to FIGS. 5 and 8, a substrate is provided. Step 802. The substrate 506 can be, for example, a silicon substrate. A cavity 501 is formed in the substrate 506, the cavity 501 defines surfaces 503, 505 and opens to one surface (the top surface in the illustrated embodiment). Step 804. The, the emitter 202 and the detector 204 are formed on the surfaces 503 and 505 of the cavity 501. Steps 806 and 808. As illustrated and also discussed above, the emitter 202 is mounted such that emitted light is generally directed up and toward the center of the cavity 501. The detector 204 is positioned generally facing center of the cavity so as to detect reflected light 216.

From the foregoing, it will be apparent that the present invention is novel and offers advantages over the current art. Although specific embodiments of the invention are described and illustrated above, the invention is not to be limited to the specific forms or arrangements of parts so described and illustrated. For example, differing configurations, sizes, or materials may be used but still fall within the scope of the present invention. The invention is limited by the claims that follow.

What is claimed is:

1. An optical encoder comprising:
a leadframe substrate having a base portion, an emitter portion and a detector portion;
an emitter operable to emit light, said emitter mounted on the emitter portion of said leadframe substrate;
a detector operable to detect light, said detector mounted on the detector portion of said leadframe substrate;
wherein the emitter portion of said leadframe substrate lies at an emitter angle relative to the base portion such that light emitted by said emitter is generally directed at a desired direction.

2. The optical encoder recited in claim 1 wherein the detector portion of said leadframe substrate lies at a detector angle relative to the base portion such that light reflected from a code scale is generally directed toward said detector.

3. The optical encoder recited in claim 2 wherein the emitter angle and the detector angle have same absolute value.

4. The optical encoder recited in claim 1 further comprising encapsulant encapsulating said emitter and said detector.

5. The optical encoder recited in claim 4 wherein the encapsulant defines an emitter lens adapted to direct light from said emitter toward a desired direction.

6. The optical encoder recited in claim 4 wherein the encapsulant defines a detector lens adapted to direct reflected light toward said detector.

7. The optical encoder recited in claim 1 further comprising an emitter lens adapted to direct light from said emitter toward a desired direction.

8. The optical encoder recited in claim 1 further comprising a detector lens adapted to direct reflected light toward said detector.

9. An optical encoder comprising:
a substrate defining a cavity having surfaces;
an emitter operable to emit light, said emitter mounted on a first surface of the cavity; and
a detector operable to detect light, said detector mounted on a second surface of the cavity.

10. The optical encoder package recited in claim 9 wherein said substrate is Silicon substrate.

11. The optical encoder package recited in claim 9 wherein said emitter is positioned such that emitted light is generally directed up and toward the center of the cavity.

12. The optical encoder package recited in claim 9 wherein said detector is positioned generally facing up and center of the cavity.

13. A method of manufacturing an apparatus, said method comprising:
providing a leadframe substrate;
mounting an emitter on the leadframe substrate;
mounting a detector on the leadframe substrate; and
bending the leadframe such that a base portion and an emitter portion are formed, said emitter portion being at an emitter angle relative to the base portion.

14. The method recited in claim 13 further comprising a step of bending the leadframe such that a detector portion is formed, said detector portion resulting at a detector angle relative to the base portion.

15. The method recited in claim 14 wherein the emitter angle and the detector angle have same absolute value.

16. The method recited in claim 13 further comprising a step of encapsulating said emitter and said detector.

17. The method recited in claim 16 wherein the encapsulant defines an emitter lens adapted to direct light from said emitter toward a desired direction.

18. The method recited in claim 16 wherein the encapsulant defines a detector lens adapted to direct reflected light toward said detector.

19. A method of manufacturing an apparatus, said method comprising:
providing a substrate;
fabricating a cavity in the substrate, the cavity defining surfaces;
mounting an emitter on a first surface of the cavity; and
mounting a detector on a second surface of the cavity.

20. The method recited in claim 19 wherein said substrate is Silicon substrate.

21. The method recited in claim 19 wherein said emitter is positioned such that emitted light is generally directed up and toward the center of the cavity.

22. The method recited in claim 19 wherein said detector is positioned generally facing up and center of the cavity.
